(19) United States
(12) Patent Application Publication
(10) Pub. No.: US 2011/0320613 A1
(43) Pub. Date: Dec. 29, 2011

(54) METHOD OF ESTABLISHING COMMUNICATION BETWEEN USERS AND PROFESSIONAL SERVICE PROVIDERS

(75) Inventors: Jay Mandal, Fremont, CA (US); Nitin Gupta, Milpitas, CA (US); Steven Chee-Man Kam, Mountain View, CA (US)

(73) Assignee: Law Pivot Inc., Fremont, CA (US)

(21) Appl. No.: 13/172,205

(22) Filed: Jun. 29, 2011

Related U.S. Application Data
(60) Provisional application No. 61/359,360, filed on Jun. 29, 2010.

(51) Int. Cl. G06F 15/16

(52) U.S. Cl. 709/227

(57) ABSTRACT

The invention relates to a method of establishing communication between one or more users and one or more professional service providers. The professional service provides include, but are not limited to legal professionals, medical professionals, doctors, taxation professionals, accounting professionals, and financial professionals. Information corresponding to one or more professional service requirements of the user is obtained. The information includes basic information and confidential information. The basic information is transmitted to the one or more professional service providers based on the one or more professional service requirements of the user. Thereafter, communication is established between the user and the one or more professional service providers based on conflict of interest and an affirmative confirmation from the one or more professional service providers.

### CLAIM TO PRIORITY

This patent application claims priority to U.S. Provisional Application No. 61/359,360, filed on Jun. 29, 2010, the contents of which are hereby incorporated by reference into this application as if set forth herein in full.

### FIELD OF THE INVENTION

The invention, in general, relates to a method of establishing a communication session between one or more users and one or more professional service providers. More specifically, the invention relates to a method of dynamically establishing communication between a user and one or more professional service providers based on information pertaining to professional service requirements of the user and an absence of an actual or possible conflict of interest.

### BACKGROUND OF THE INVENTION

In certain professional services, the duty of loyalty owed by a professional service provider to a current or a former client or user prohibits the professional service provider from representing a prospective client with interests adverse to the interests of a current client or a former client. The professional service provides include, but are not limited to legal professionals, medical professionals, doctors, taxation professionals, accounting professionals, and financial professionals. As a standard practice, the professional service provider checks for an existing or a possible conflict of interest prior to agreeing to represent a prospective client. Typically, the professional service provider reviews client files and previous client records to determine whether the substance of a prior professional representation or retention is in conflict with interests of a prospective client. Subsequently, a professional service provider may represent to the prospective client on confirmation that a conflict of interest does not exist. However, if a conflict of interest is discovered, i.e. the professional service provider has represented a client whose interests may be substantially related to and are adverse to a prospective client, the professional service provider may be disqualified from representing the prospective client. Therefore, the performance of conflict checks serves both to prevent confidential client information corresponding to one client from being used for or against another client and a possible subsequent disqualification of the professional service provider.

Continuing developments in internet communications provide professional service providers with new and additional channels through which to connect with prospective clients. Likewise, prospective clients have started seeking answers to their professional issues by posting questions on the professional issues on various internet websites. Professional service providers respond to such questions from prospective clients and provide professional advice using such internet websites. However, such professional service providers may encounter professional hazards in building relationships or acquiring business in this manner because the interests of prospective clients acquired through such means from internet websites may conflict with the interests of a current or a former client. Most websites on the internet offer little to no facilities for pre-screening such prospective clients over the internet, leaving professional service providers exposed to unanticipated or unperceived conflicts of interest. Furthermore, a client may expose confidences relating to a professional issue to a professional service provider who may not be able to represent the client due to a possible conflict of interest. The professional service provider is thereby exposed to the professional issue resulting in possible disqualifying conflicts of interests. Thus, a professional service provider would derive a professional benefit from being protected from exposure to a potential or actual disqualifying conflicts of interest prior to the professional service providers' provision of professional advice or consultations to prospective clients over the internet.

Therefore, there is a need in the art for a method of establishing communication between a prospective client and a professional service provider based on whether conflict of interest exists. There is also a need for concealing confidential communication of a prospective client from a professional service provider whose clients' interests' conflict with the interests of the prospective client.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 illustrates a block diagram showing an exemplary environment in which various embodiments of the invention can function.

FIG. 2 illustrates a flow diagram of a method of establishing communication between a user and one or more professional service providers based on conflict of interest and an affirmative confirmation from the one or more professional service providers in accordance with an embodiment of the invention.

FIG. 3 illustrates a flow diagram of a method of transmitting basic information corresponding to one or more professional service requirements of the user in accordance with an embodiment of the invention.

FIG. 4 illustrates a flow diagram of a method of requesting for responses from one or more professional service providers in accordance with an embodiment of the invention.

FIG. 5 illustrates a flow diagram of a method of selecting one or more professional service providers in accordance with an embodiment of the invention.

FIG. 6 illustrates a system for establishing communication between a user and one or more professional service providers based on conflict of interest and an affirmative confirmation from the one or more professional service providers in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the invention, it should be observed that the embodiments reside primarily in establishing communication between a user and one or more professional service providers based on whether a conflict of interest exists. Accordingly, the method steps for establishing communication between the user and the one or more professional service providers based on conflict of interest and an affirmative conformation from the one or more professional service providers, and the like have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, terms such as “comprises,” “comprising,” or any other variation thereof, are intended to cover a non-exclusive inclusion, such that a process and method, comprises a list of steps does not include only those steps but may include other steps not expressly listed or inherent to such process, method, or system. An element proceeded by “comprises . . . a” does not, without more constraints, preclude the existence of additional identical elements in the process, method, article, or apparatus that comprises the element.

Pursuant to various embodiments disclosed herein, the invention provides a method of establishing communication between one or more users and one or more professional service providers. The method involves obtaining information corresponding to one more professional service requirements of a user. The information includes basic information and confidential information corresponding to the one or more professional service requirements of the user. After obtaining the information, the basic information is transmitted to the one or more professional service providers based on the one or more professional service requirements of the user. Thereafter, communication is established between the user and the one or more professional service providers based on an absence of an actual or possible conflict of interest and an affirmative confirmation from the one or more professional service providers.

The method disclosed herein describes establishing communication between a user and one or more professional service providers. It would be apparent to a person skilled in the art that the communications may be between two or more persons or entities whose professional obligations require a confirmation in clearing a check for a conflict of interest. The persons or the entities may be from a field where professional obligations require fiduciary, professional privileges and confidentiality. Such professionals requiring fiduciary, professional privileges and confidentiality include, but are not limited to legal professionals, medical professionals, doctors, taxation professionals, accounting professionals, and financial professionals. However, for illustrative purposes, the method disclosed herein describes establishing communication between a user seeking legal advice and a legal service provider such as a legal professional or a legal entity.

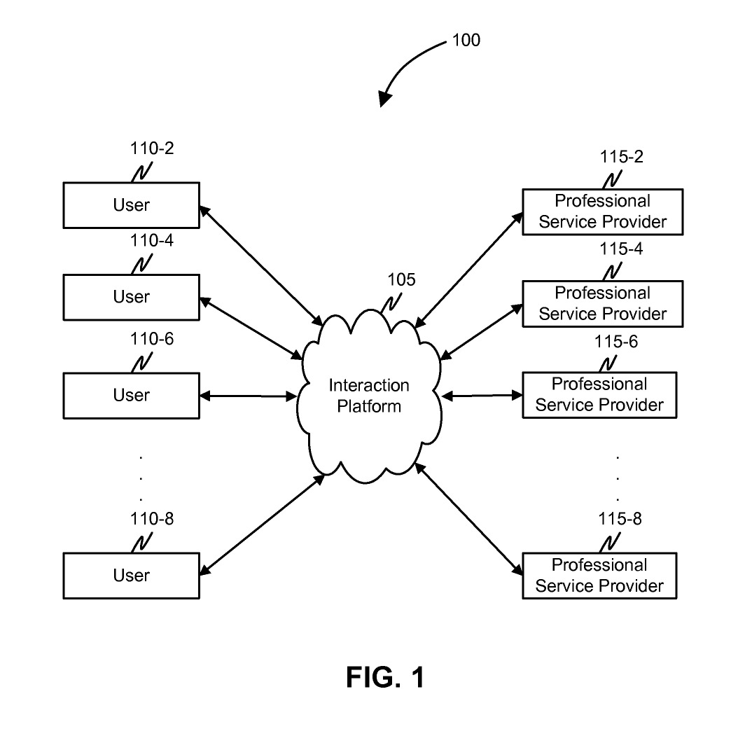

FIG. 1 illustrates an exemplary environment 100 in which various embodiments of the invention can function. Environment 100 includes an interaction platform 105, a plurality of users 110-n, and a plurality of professional service providers 115-n. The plurality of users 110-n includes a user 110-2, a user 110-4, a user 110-6, and a user 110-8. The plurality of professional service providers includes a professional service provider 115-2, a professional service provider 115-4, a professional service provider 115-6, and a professional service provider 115-8 as shown in FIG. 1.

User 110-2 of the plurality of users 110-n may be a prospective client interested in communicating with the one or more professional service providers 115-n, such as professional service provider 115-2. For example, the prospective client may be, but not limited to, an individual, a company, and a corporation, interested in communicating with professional service provider 115-2. Examples of the one or more professional service providers may be, but not limited to, a professional or an entity providing professional advice. A professional may be, for example, a legal professional, such as, for example lawyers, attorneys, and advocates offering legal assistance to clients. A legal entity may be, for example, a law firm, a business entity with one or more lawyers, offering legal assistance to clients.

Interaction platform 105 facilitates the plurality of users 110-n and the plurality of professional service providers 115-n to interact with each other. The plurality of users 110-n and the plurality of professional service providers 115-n may discuss professional matters such as one or more of a legal project, a law suit, and merger and acquisitions projects on interaction platform 105 using one or more communication devices such as an internet enabled mobile phone, a personal digital assistant, a computer, a laptop, and a tablet. Interaction platform 105 may also be utilized for communicating between the plurality of users 110-n and the plurality of professional service providers 115-n. Examples of interaction platform 105 includes, but are not limited to an instant messenger, an email service, a forum, a website, a voice based service, and a text based service. Interaction platform 105 may utilize a secure channel for securing the privacy of the plurality of users and the plurality of professional service providers.

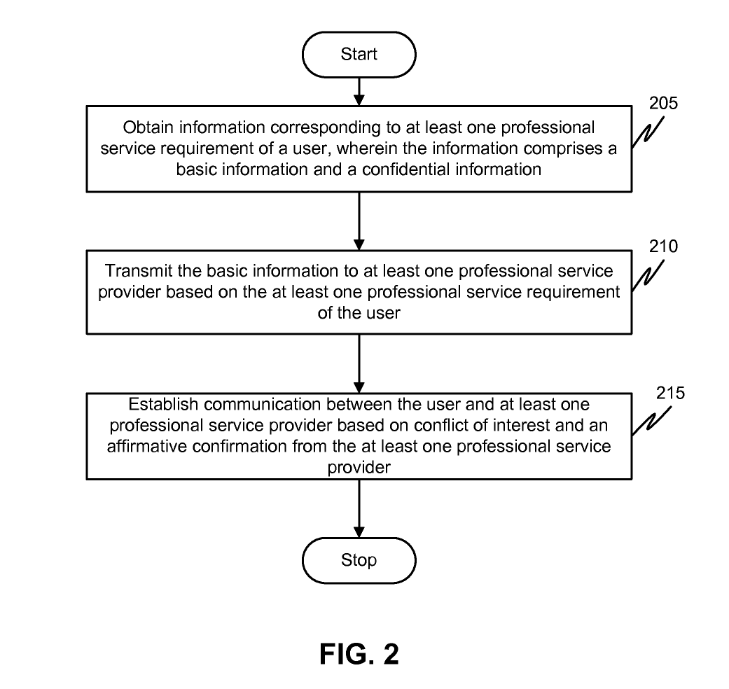

FIG. 2 illustrates a flow diagram of a method of establishing communication between a user and one or more professional service providers based on conflict of interest and an affirmative confirmation from the one or more professional service providers in accordance with an embodiment of the invention. At step 205, information corresponding to one or more professional service requirements of a user of one or more users is obtained from the user. The information may be automatically obtained from a communication device associated with the user after receiving permission from the user or the user may be asked to supply the information. The information includes basic information and confidential information corresponding to the one or more professional service requirements of the user. In an embodiment, the basic information includes one or more of an identity of the user, background information associated with the one or more professional service requirements of the user, personal information associated with the user, business information associated with the user, and a desired request for response associated with the one or more professional service requirements of the user. The basic information may also include a list of adverse or involved parties listed by the user, wherein an adverse or involved party corresponds to an entity, an organization, or an individual having interests that may conflict with interests of the user.

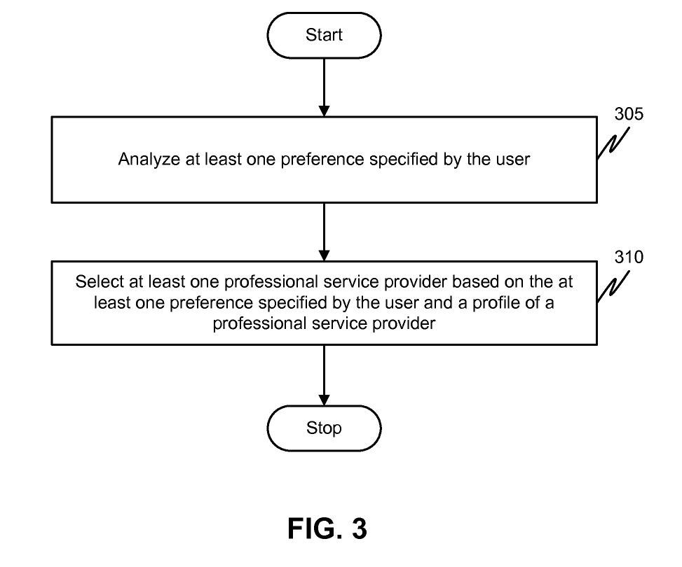

After obtaining the information, at step 210, the basic information corresponding to the one or more professional service requirements of the user is transmitted to the one or more professional service providers based on the one or more professional service requirements of the user. In order to transmit the basic information, one or more preferences specified by the user are analyzed. This is further explained in conjunction with FIG. 3. In an embodiment, the user may specify a permission that allows a specific professional service provider to view the confidential communication without having to confirm whether the professional service provider fulfills the one or more professional service requirements of the user and the one or more preferences specified by the user. In another embodiment, the user may be allowed to send the confidential information to a professional service provider by overriding the one or more professional requirements.

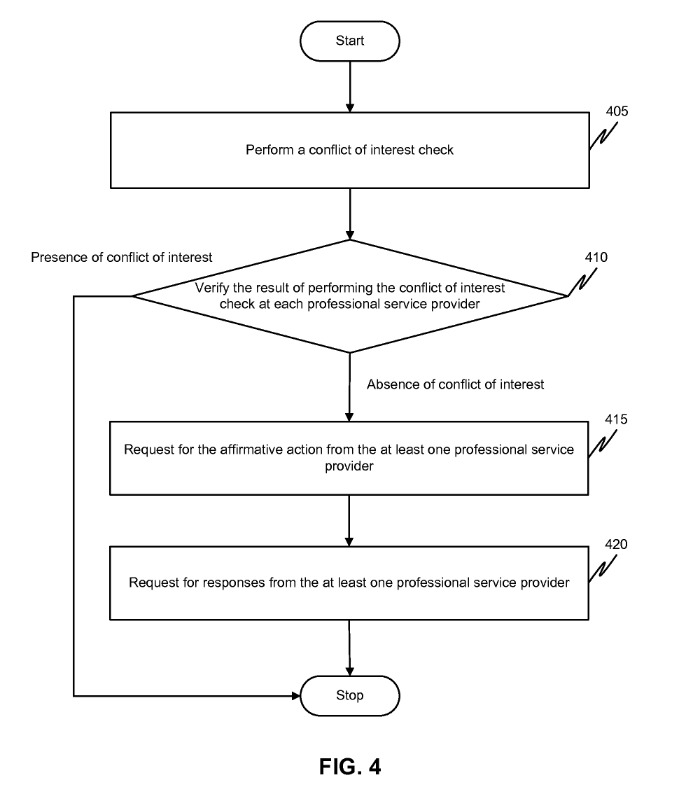

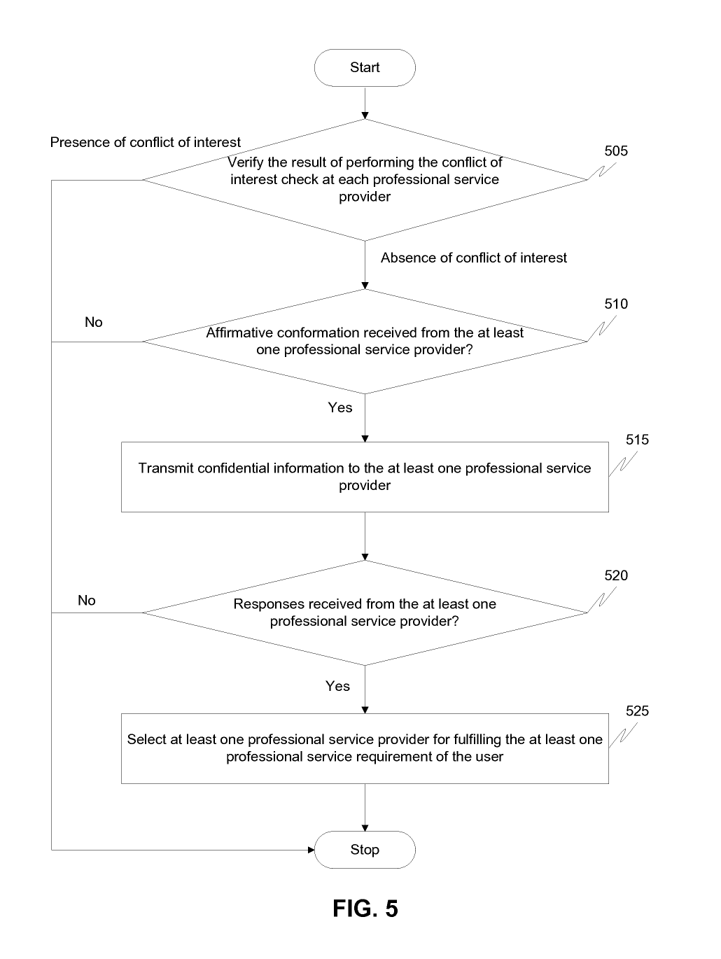

The basic information transmitted to the one or more professional service providers is utilized by each professional service provider to perform a conflict of interest check. In order to perform the conflict of interest check, each professional service provider matches the basic information corresponding to the one or more professional service requirements of the user with a list of users associated with each professional provider. After performing the conflict of interest check, each professional service provider may be requested to send an affirmative confirmation to the user. This is further explained in conjunction with FIG. 4. Thereafter, at step 215, communication is established between the user and one or more professional service providers of the one or more professional service providers based on the conflict of interest and the affirmative confirmation from the one or more professional service providers. In response to establishing communication between the user and the one or more professional service providers and based on verifying absence of an actual or possible conflict of interest and the affirmative confirmation, the confidential information corresponding to the one or more professional service requirements of the user is transmitted to the one or more professional service providers. Additionally, each professional service provider of the one or more professional service providers is requested to send responses to the users. Thereafter, the user selects one or more professional service providers for fulfilling the one or more professional service requirements based on the conflict of interest, the affirmative confirmation, and a response received from each professional service provider. This is further explained in conjunction with FIG. 5.

FIG. 3 illustrates a flow diagram of a method of transmitting the basic information corresponding to one or more professional service requirements of the user in accordance with an embodiment of the invention. After obtaining the information corresponding to the one or more professional service requirements of the user, at step 305, one or more preferences specified by the user are analyzed. The one or more preferences specified by the user describe criteria for filtering the one or more professional service providers. For example, a preference specified by the user may define required attributes of a professional service provider such as, but not limited to, a required qualification level, a required domain level, a required sub-domain level, a required geographical location, and a required expertise level. In an embodiment, the one or more preferences may also specify a list of adverse parties listed by the user.

Based on the analysis of the one or more preferences specified by the user, at step 310, one or more professional service providers are selected. In order to select the one or more professional service providers, profiles of the one or more professional service providers are also analyzed in conjunction with the one or more preferences specified by the user. For example, the one or more preferences may be compared against the profiles of the one or more professional service providers to determine professional service providers that satisfy the one or more preferences. Additionally, a profile of a professional service provider also facilitates in differentiating the professional service provider from the one or more professional service providers. After selecting the one or more professional service providers, the basic information is transmitted to the one or more selected professional service providers.

In response to receiving the basic information, each professional service provider performs a conflict of interest check. The conflict of interest check is performed to determine whether a conflict exists for a professional service provider to fulfill the one or more professional service requirements of the user. In response to performing the conflict of interest check, each professional service provider is requested to send an affirmative confirmation and a response to the user. This is further explained in conjunction with FIG. 4.

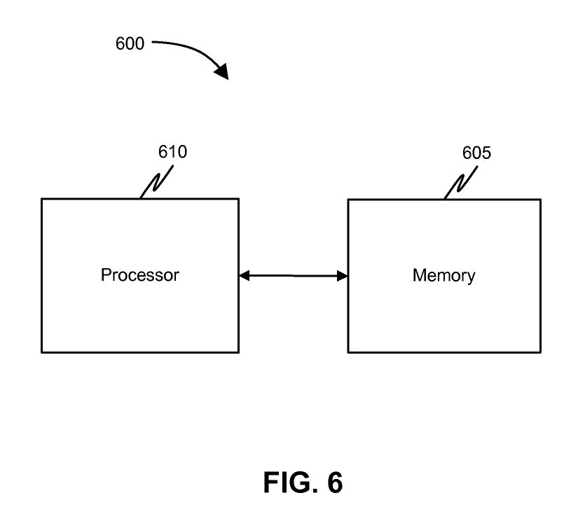

FIG. 4 illustrates a flow diagram of a method of requesting for responses from one or more professional service providers in accordance with an embodiment of the invention. After transmitting the basic information, at step 405, a conflict of interest check is performed for each professional service provider. The basic information includes a list of adverse or involved parties listed by the user, wherein an adverse or involved party corresponds to an entity, an organization, or an individual having interests that conflict with interests of the user. This has already been explained in conjunction with FIG. 2. The conflict of interest check is performed by matching the basic information of the user with a list of users associated with each professional service provider. The list of users includes details corresponding to one more users associated with each professional service provider. In an embodiment, the list of users may be provided by each professional service provider. In another embodiment, the list of users may be automatically determined for each professional service provider. The list of users is frequently updated for each professional service provider. In an embodiment, the list of users may be updated manually by the one or more professional service providers. In another embodiment, the list of users may be updated automatically for each professional service provider. This is further explained in conjunction with FIG. 6.

After performing the conflict of interest check, each professional service provider is requested to submit the result of performing of the conflict of interest check to the user. The result of performing of conflict of interest check corresponds to one or more of a presence of an actual or possible conflict of interest or an absence of actual or possible conflict of interest. In an embodiment, the result of performing of the conflict of interest check at each professional service provider may be automatically performed, collected, and submitted to the user. The result may be submitted through one or more formats such as, but not limited to, an online report, an email, voice, text, a pop-up, and using a widget.

After receiving the result of performing of the conflict of interest check, at step 410, the result is verified for each professional service provider. The result is verified by analyzing the result for each professional service provider. Thereafter, the one or more professional service providers are categorized into one or more groups based on analyzing the result for each professional service provider. For example, professional service providers for whom the result of conflict of interest check is a presence of an actual or possible conflict of interest may be categorized into a first group and professional service providers for whom the result of conflict of interest check is absence of an actual or possible conflict of interest may be categorized into a second group. It will be evident to a person skilled in the art that various other criteria may be employed in addition to the result of performing of the conflict of interest check for categorizing the one or more professional service providers into the one or more groups.

Thereafter, one or more professional service providers are identified for whom the result of conflict of interest check corresponds to an absence of an actual or possible conflict of interest. In response to identifying the one or more professional service providers for whom the result of conflict of interest check corresponds to an absence of an actual or possible conflict of interest, at step 415, a request is sent to the one or more professional service providers for an affirmative confirmation. In response to receiving the request, the one or more professional service providers send the affirmative confirmation to the user. In an embodiment, the one or more professional service providers may send the affirmative confirmation to the user by clicking on one or more of a button, a check box, a field, and a user form. It will be evident to a person skilled in the art that the affirmative confirmation may be sent to the user using various other means. The affirmative confirmation by a professional service provider holds the professional service provider to applicable to rules and laws of professional conduct and civil liability without affecting the state of other professional service providers who have not yet provided an affirmative confirmation. Further, after sending the affirmative confirmation, the professional service provider may owe a duty of confidentiality and a professional responsibility to the user. The affirmative confirmation is not requested from professional service providers for whom the result of the conflict of interest check corresponds to a presence of an actual or possible conflict of interest.

In an embodiment, the affirmative confirmation may be requested from each professional service provider, wherein each professional service is requested to provide the result of performing of a conflict of interest check along with sending the affirmative confirmation to the user. In another embodiment, one or more of a tool, algorithms, and software may be used for recording whether the one or more professional service providers have confirmed the presence or the absence of an actual or possible conflict of interest and sent the affirmative confirmation to the user. The record of confirmation of the presence or the absence of an actual or possible conflict of interest and the affirmative confirmation for each professional service provider may be displayed to the user to enable the user to keep a log of professional service providers who have sent the affirmative confirmation and the result of performing of the conflict check.

After receiving the affirmative confirmation from the one or more professional service providers, the user may send the confidential information to the one or more professional service providers. This is further explained in conjunction with FIG. 5. After sending the confidential information, at step 420, the one or more professional service providers are requested for responses corresponding to the one or more professional service requirements of the user. In an embodiment, the one or more professional service providers may be requested for responses prior to sending the confidential information. In another embodiment, the request for response may be sent along with the confidential information. In yet another embodiment, the confidential information may be divided into one or more sets. The user may transfer certain sets prior to sending the request for responses and withhold certain sets until responses are received from the one or more professional service providers. After receiving responses, the user may then release the withheld sets and transfer it to the one or more professional service providers. It will be evident to a person skilled in the art that various other combinations of sending the confidential information and requesting for responses can be implemented. Based on the received responses, the user may select one or more professional service providers for fulfilling the one or more professional service requirements of the user. This is further explained in conjunction with FIG. 5.

FIG. 5 illustrates a flow diagram of a method of selecting the one or more professional service providers in accordance with an embodiment of the invention. At step 505, the result of performing of the conflict of interest check is verified at each professional service provider in response to sending the basic information. In response to verifying the result of a conflict of interest check, one or more professional service providers are identified who have indicated an absence of an actual or possible conflict of interest. After identifying the one or more professional service providers, at step 510, it is determined whether affirmative confirmation is received from the one or more professional service providers. If the affirmative confirmation is received at the user, then at step 515, the confidential information corresponding to the one or more professional service requirements of the user is transmitted to the one or more professional service providers. If the affirmative confirmation is not received from the one or more professional service providers, the confidential information is not transmitted. Therefore, a professional service provider does not receive the confidential information unless an affirmative confirmation is sent from the professional service provider to the user. The transmission of the confidential communication to the one or more professional service providers in response to receiving the confirmation of the absence of an actual or possible conflict of interest and the affirmative confirmation prevents exposure of the confidential communication to a professional service provider with a presence of an actual or possible conflict of interest.

In response to receiving the confidential information, the one or more professional service providers transmit responses corresponding to the one or more professional service requirements of the user. In an embodiment, the confidential information may be sent after receiving responses from the one or more professional service providers. This is already explained in conjunction with FIG. 4. Thereafter, at step 520, it is determined whether responses are received from the one or more professional service providers. If responses are received, the user may review one or more responses. After reviewing the one or more responses, at step 525, one or more professional service providers are selected by the user for fulfilling the one or more professional service requirements of the user. In an embodiment, the one or more professional service providers may be selected automatically by specifying certain rules and policies. The rules and policies may be specified by the user and responses are evaluated against the specified rules and policies for selecting the one or more professional service providers. In another embodiment, the one or more professional service providers may be selected in a semi-automatic manner, wherein responses are filtered by evaluating responses against the specified rules and policies. After filtering responses, the user may manually select one or more professional service providers corresponding to the filtered responses. Thereafter, the one or more professional service requirements of the users are fulfilled by the one or more professional service providers that have been selected.

FIG. 6 illustrates a system 600 for establishing communication between a user and one or more professional service providers based on conflict of interest and an affirmative confirmation from the one or more professional service providers in accordance with an embodiment of the invention. System 600 may correspond to a computing device within which a set of instructions, for causing the system to perform any one or more of the methodologies discussed herein, may be executed. Examples of the system may correspond to a personal computer (PC), a tablet PC, a server, a set-top box (STB), a Personal Digital Assistant (PDA), a mobile telephone, a web appliance, or any machine capable of executing instructions.

System 600 includes a memory 605, and a processor 610 operatively coupled to memory 605. A plurality of users utilizes system 600 for establishing communication with a plurality of professional service providers. In order to access memory 605 and processor 610, each user and each professional service provider may use one or more communication devices such as, but not limited to a mobile phone, a personal digital assistant, a computer, and a laptop. Thus, memory 605 and processor 610 is operatively accessible to the plurality of users and the plurality of professional service providers.

Processor 610 obtains information corresponding to one or more professional service requirements of a user of the one or more users. In an embodiment, the information may be stored in memory 605. In another embodiment, the information may be stored in a communication device associated with the user. The information includes basic information and confidential information. After obtaining the information corresponding to the one or more professional service requirements of the user, processor 610 analyzes the information to identify the basic information and the confidential information. The basic information includes one or more of an identity of the user, background information associated with the one or more professional service requirements of the user, personal information associated with the user, business information associated with the user, and a desired request for response associated with the one or more professional service requirements of the user. This has already been explained in conjunction with FIG. 2. In an embodiment, processor may request the user to specify the basic information and the confidential information. In another embodiment, the user may supply processor 610 with the basic information and the confidential information.

Thereafter, processor 610 transmits the basic information to the one or more professional service providers based on the one or more professional service requirements of the user. Processor 610 transmits the basic information based on one or more preferences specified by the user. The one or more preferences are analyzed by processor 610 to determine criteria for transmitting the basic information. Based on the one or more preferences, processors 610 filters the one or more professional service providers. Examples of the one or more preferences include, but are not limited to, a required qualification level, a required domain level, a required sub-domain level, a required geographical location, and a required expertise level. In an embodiment, the one or more preferences may also specify a list of adverse parties listed by the user. This has already been explained in conjunction with FIG. 3.

In addition to the one or more preferences, processor 610 also analyzes profiles associated with the one or more professional service providers. For example, processor 610 may retrieve a profile of a professional service provider after analyzing the one or more preferences specified by the user. The profile of the professional service provider includes details about professional experience of the professional service provider. In an embodiment, the profile may also include details about previous transactions, user rating, area of expertise, geographical location, and a charge rate of the professional service provider. After analyzing the one or more preferences, processor 610 selects one or more professional service providers from the one or more professional service providers based on the one or more preferences specified by the user and the profiles of the one or more professional service providers. In an embodiment, processor 610 may map one or more of the one or more professional service requirements and the one or preferences of the user for selecting the one or more professional service providers.

After selecting the one or more professional service providers, processor 610 establishes communication between the user and the one or more professional service providers. In order to establish communication, processor 610 performs a conflict of interest check at each professional service provider of the one or more professional service provider. The conflict of interest check is performed by matching the basic information of the user with a list of users associated with each professional service provider. The list of users associated with each professional service provider includes details corresponding to one or more users and is stored in memory 605. The details corresponding to the one or more users include a name of the user, a domain, a sub-domain, a geographical location, time information, and a nature of transaction. Processor 610 analyzes the basic information corresponding to the one or more professional service requirements of the user and evaluates the basic information against the list of users associated with each professional service provider. The result of performing the conflict of interest check corresponds to one or more of a presence of an actual or possible conflict of interest, and an absence of an actual or possible conflict of interest.

After performing of the conflict of interest check, the result of performing of the conflict of interest check is stored in memory 605. Alternatively, processor 610 may transmit the result of the performing of the conflict of interest check of each professional service provider to the user. In an embodiment, processor 610 may collate the result of performing of the conflict of interest check of the one or more professional service providers in a single report and thereafter transmit the report to the user. Thereafter, processor 610 verifies the result of performing of the conflict of interest check at each professional service provider. The result is verified by analyzing the result for each professional service provider. After verifying the result, processor 610 categorizes the one or more professional service providers into one or more groups based on analyzing the result for each professional service provider. In another embodiment, the user may directly access memory 605 for verifying the result of performing of the conflict of interest check. In response to verifying the result, processor 610 identifies one or more professional service providers for whom the result of performing of conflict of interest check corresponds to an absence of an actual or possible conflict of interest. After identifying the one or more professional service providers for whom the result corresponds to absence of an actual or possible conflict of interest, processor 610 sends a request to the one or more professional service providers for an affirmative confirmation. In response to receiving the request, the one or more professional service providers send the affirmative confirmation. The affirmative confirmation is used by a professional service provider to inform the user that there is no conflict of interest for the professional service provider in representing the user and in fulfilling the one or more professional service requirements of the user. This has already been explained in conjunction with FIG. 4.

Thereafter, processor 610 requests the one or more professional service providers to send responses corresponding to the one or more professional service requirements of the user. In order to determine the one or more professional service providers to whom to request for responses, processor 610 determines whether the result of performing of conflict of interest check corresponds to absence of an actual or possible conflict of interest and whether an affirmative confirmation is received from each of the one or more professional service providers. If the result corresponds to absence of an actual or possible conflict of interest and the affirmative confirmation is received, processor 610 selects one or more professional service providers from the one or more professional service providers. In an embodiment, processor 610 may send the confidential information prior to sending the request for responses. In another embodiment, processor 610 may send only a portion of confidential information prior to sending the request for responses. This has already been explained in conjunction with FIG. 4.

After receiving responses, processor 610 transmits responses to the user for review. The user reviews responses and selects one or more professional service providers for fulfilling the one or more professional service requirements. Thereafter, processor 610 retrieves the confidential information corresponding to the one or more professional service requirements and transmits the confidential information to the one or more professional service providers selected by the user. Processor 610 may transmit the confidential information to the one or more professional service providers selected by the user based on whether one or more of absence of an actual or possible conflict of interest exists, whether an affirmative confirmation is received, and based on a response of a professional service provider. Based on the confidential information received by the one or more professional services, the one or more professional service requirements of user 615-2 are fulfilled.

In an exemplary embodiment of the invention, consider a company “Company” that requires a legal service provider to fulfill its legal service requirement. The legal service requirement of Company may correspond to a technology licensing deal in the domain of Intellectual Property. Company uses the system described herein, to select one or more legal service providers. In order to select the one or more legal service providers, Company stores information corresponding to the legal service requirement in memory 605. In an embodiment, the information may be stored in a memory associated with a communication device of Company. Processor 610 obtains the information corresponding to the legal service requirement of Company and analyzes the information to identify basic information and confidential information associated with the legal service requirement. The basic information includes identity of Company, background information associated with the legal service requirement of Company, personal information associated with Company, business information associated with Company, a list of adverse or involved parties, and a desired request for response associated with the legal service requirement of Company. The confidential information includes complete details of the legal service requirement, private data, and understanding material associated with the legal service requirement.

After identifying the basic information, processor 610 displays the basic information on one or more of, but not limited to, a web portal, a screen corresponding to the communication device associated with Company, a screen corresponding to communication devices associated with the one or more legal service providers, an application, a website, and a forum. For example, the basic information may be displayed on a web portal. Further, the web portal may also display basic information corresponding to legal service requirements of other users. The basic information can be accessed by Company and the one or more legal service providers by logging into the web portal or registering with the web portal to access the services provided by the web portal. Alternatively, the basic information can be accessed using a mail service that is configured to receive updates and feeds from the web portal. Additionally, the basic information may also be tagged based on one or more criteria for facilitating the one or more legal service providers to understand the legal service requirements of the users. In an embodiment, the basic information may be transmitted directly to communication devices associated with the one or more legal service providers.

In order to transmit the basic information to the one or more legal service providers, processor 610 analyzes one or more preferences specified by Company. For example, a preference specified by Company may required the legal service provider to have at least 10 years of experience in handling legal cases in the domain of Intellectual Property. In the same manner, another preference may require the legal service provider to be based out of United States of America. Processor 610 analyzes the one or more preferences specified by Company to select one or more legal service providers who satisfy the one or more preferences. In addition to the one or more preferences, processor 610 also analyzes profiles associated with the one or more legal service providers. Thus, the one or more legal service providers may be selected based on both the one or more preferences and the profiles of the one or more legal service providers. In an embodiment, Company may manually select a legal service provider for transmitting the basic information.

After selecting the one or more legal service providers, processor 610 establishes communication between Company and the one or more legal service providers. For example, processor 610 establishes communication between Company and a legal service provider “Lawyer”. In order to establish communication between Company and Lawyer, a conflict of interest check needs to be performed by Lawyer. The conflict of interest check is performed by matching the basic information of Company with a list of users associated with Lawyer. Lawyer may obtain more information about Company and view a summarized profile of Company by clicking on Company's name or by rolling a mouse cursor over Company's name. Further, Lawyer may view a complete profile of Company by clicking on the Company's name in the summarized profile. Thus, based on the list of adverse parties and other information corresponding to the basic information, processor 610 performs the conflict of interest check by matching the basic information with the list of users associated with Lawyer. Lawyer will not be allowed to view the confidential information associated with the legal service requirement until the conflict of interest check is performed. The result of performing the conflict of interest check corresponds to one or more of a presence of an actual or possible conflict of interest, or an absence of actual or possible conflict of interest. For example, the result of conflict of interest check corresponds to absence of an actual or possible conflict of interest for Lawyer.

After performing the conflict of interest check, the result is transmitted to Company. The result is verified by processor 610 after transmitting the result to Company. In an embodiment, the result may be manually verified by Company. Based on the verification of result, Company is provided with a list of one or more legal service providers for whom the result corresponds to absence of an actual or possible conflict of interest. For example, Company would be notified that there is absence of an actual or possible conflict of interest for Lawyer with respect to the legal service requirement of Company. Thereafter, Company may send a request for an affirmative confirmation to Lawyer. Alternatively, processor 610 may send the request for the affirmative confirmation to Lawyer. Lawyer may be provided with a “conflict clearance” button for sending the affirmative confirmation to Company. Thus, clicking on the conflict clearance button would indicate that Lawyer has acknowledged the absence of an actual or possible conflict of interest as well as provided Company with the affirmative confirmation.

Thereafter, processor 610 requests Lawyer to send a response corresponding to the legal service requirement. Based on one or more of response, absence of an actual or possible conflict of interest, and the affirmative confirmation, processor 610 transmits the confidential information to Lawyer. It will be evident to a person skilled in the art that Company may select other legal service providers also based on responses that are received for the legal service requirement. The confidential information includes the complete details corresponding to the legal service requirement that is required by Lawyer for fulfilling the legal service requirement. Further, Lawyer can access the confidential information after transmitting the affirmative confirmation and the result of performing of the conflict of interest check. In response to the transmission of the confidential information, Lawyer starts working on the legal service requirement. Response to the legal service requirement is sent to Company once Lawyer fulfills the requirement. After Lawyer sends the response, the legal service requirement that has been answered and fulfilled is indicated to differentiate the answered legal service requirement from an unanswered legal service requirement.

The method disclosed herein, establishes communication between user and one or more professional service providers based on whether a conflict of interest exists. The method conceals confidential information of a user from a professional service provider whose clients' interests may potentially conflict with the interests of the user. Further, professionals are shielded from being exposed to a conflict of interest and possible disqualification by preventing exposure of confidential communication to a professional with a conflict of interest. Professionals are provided an opportunity to conduct an independent investigation and then agree or refuse to review a confidential communication. Therefore, the method assures a user that a professional service provider can represent the user. Further, the method also provides an assurance to the user that a professional service provider with a conflict of interest does not view the confidential communication corresponding to the user.

Those skilled in the art will realize that the above recognized advantages and other advantages described herein are merely exemplary and are not meant to be a complete rendering of all of the advantages of the various embodiments of the invention.

In the foregoing provisional specification, specific embodiments of the invention have been described. However, one of ordinary skill in the art appreciates that various modifications and changes can be made without departing from the scope of the invention as set forth by the provisional specification. Accordingly, the provisional specification and figures are to be regarded in an illustrative rather than a restrictive sense, and all such modifications are intended to be included within the scope of the invention.

What is claimed is:

1. A method of establishing communication between at least one user and at least one professional service provider, the method comprising:
obtaining information corresponding to at least one professional service requirement of a user of the at least one user, wherein the information comprises basic information and a confidential information corresponding to the at least one professional service requirement of the user;
transmitting the basic information to the at least one professional service provider based on the at least one professional service requirement of the user; and
establishing communication between the user and at least one professional service provider based on conflict of interest and an affirmative confirmation from the at least one professional service provider.

2. The method of claim 1, wherein the basic information comprises at least one of an identity of the user, background information associated with the at least one professional service requirement of the user, personal information associated with the user, business information associated with the user, and a desired request for response associated with the at least one professional service requirement.

3. The method of claim 1, wherein transmitting the basic information comprises:
analyzing at least one preference specified by the user; and
selecting at least one professional service provider based on the at least one preference specified by the user and a profile of a professional service provider.

4. The method of claim 3, wherein a preference of the at least one preference corresponds to a required qualification level, a required domain level, a required sub-domain level, a required geographical location, and a required expertise level.

5. The method of claim 1, wherein establishing communication further comprises performing a conflict of interest check, wherein the conflict of interest check is performed by matching the basic information of the user with a list of users associated with each professional service provider, the list of users comprising details corresponding to at least one user associated with each professional service provider.

6. The method of claim 5, wherein establishing communication further comprises verifying the result of performing of the conflict of interest check at each professional service provider, wherein a result of performing of the conflict of interest check corresponds to at least one of a presence of an actual or possible conflict of interest, and an absence of an actual or possible conflict of interest.

7. The method of claim 6, wherein establishing communication further comprises requesting for the affirmative confirmation from the at least one professional service provider in response to the absence of an actual or possible conflict of interest.

8. The method of claim 7, wherein establishing communication further comprises requesting for responses from the at least one professional service provider in response to the absence of an actual or possible conflict of interest.

9. The method of claim 8, wherein establishing communication further comprises transmitting the confidential information to the at least one professional service provider based on the absence of an actual or possible conflict of interest, the affirmative confirmation from the at least one professional service provider, and responses from the at least one professional service provider.

10. The method of claim 9, wherein establishing communication further comprises selecting at least one professional service provider for fulfilling the at least one professional service requirement of the user.

11. A system for establishing communication between at least one user and at least one professional service provider, the system comprising:
a memory;
a processor operatively coupled to the memory, wherein the processor is configured to:
obtain information corresponding to at least one professional service requirement of a user of the at least one user, wherein the information comprises of basic information, and confidential information corresponding to the at least one professional service requirement of the user;
transmit the basic information to the at least one professional service provider based on the at least one professional service requirement of the user; and
establish communication between the user and at least one professional service provider based on conflict of interest and an affirmative confirmation from the at least one professional service provider.

12. The system of claim 11, wherein the processor is further configured to:
analyze at least one preference specified by the user; and
select at least one professional service provider based on the at least one preference specified by the user and a profile of a professional service provider.

13. The system of claim 11, wherein the processor is further configured to perform a conflict of interest check, wherein the conflict of interest check is performed by matching the basic information of the user with a list of users associated with each professional service provider, the list of users comprising details corresponding to at least one user associated with each professional service provider.

14. The system of claim 13, wherein the processor is further configured to verify the result of performing of the conflict of interest check at each professional service provider, wherein a result of performing of the conflict of interest check corresponds to at least one of a presence of an actual or possible conflict of interest, and an absence of an actual or possible conflict of interest.

15. The system of claim 14, wherein the processor is further configured to request for the affirmative confirmation from the at least one professional service provider in response to the absence of an actual or possible conflict of interest.

16. The system of claim 15, wherein the processor is further configured to request for responses from the at least one professional service provider in response to the absence of an actual or possible conflict of interest.

17. The system of claim 16, wherein the processor is further configured to transmit the confidential information to the at least one professional service provider based on the absence of an actual or possible conflict of interest, the affirmative confirmation from the at least one professional service provider, and responses from the at least one professional service provider.

18. The system of claim 17, wherein the processor is further configured to select at least one professional service provider for fulfilling the at least one professional service requirement of the user.
